(19) United States
(12) Patent Application Publication
(10) Pub. No.: US 2013/0274968 A1
(43) Pub. Date: Oct. 17, 2013

(54) ECO-CLIMATE CONTROL SYSTEM

(71) Applicants: Donald Federico, Grass Lake, MI (US); Nicholas Scott Sitarski, Ypsilanti, MI (US); Daniel Todd Smith, Ann Arbor, MI (US); Yasushi Kondo, Aichi (JP)

(72) Inventors: Donald Federico, Grass Lake, MI (US); Nicholas Scott Sitarski, Ypsilanti, MI (US); Daniel Todd Smith, Ann Arbor, MI (US); Yasushi Kondo, Aichi (JP)

(73) Assignees: Denso Corporation, Kariya-shi (JP); Toyota Motor Engineering & Manufacturing North America, Inc., Erlanger, KY (US)

(21) Appl. No.: 13/446,104

(22) Filed: Apr. 13, 2012

(51) Int. Cl. G06F 17/00

(52) U.S. Cl. 701/22

(57) ABSTRACT

An interior comfort control system that allows a driver and/or passenger of an electric vehicle to balance between driving range for the vehicle and interior comfort and thereby obtain an optimum driving range-interior comfort combination. The interior comfort control system can include an electric vehicle having an interior and an interior comfort control module (ICCM). The ICCM can have an Off-Mode, a Normal-Mode, and an Eco-Mode with the Normal-Mode operable to reach a desired vehicle interior temperature using a first air temperature change rate and the Eco-Mode operable to reach the same desired vehicle interior temperature using a second air temperature change rate, the second air temperature change rate being less than the first air temperature change rate.

### FIELD OF THE INVENTION

The present invention is related to an interior comfort control system for a motor vehicle, and in particular to an interior comfort control system for an electric vehicle that allows an operator to balance between driving range and interior comfort for the vehicle and thereby obtain an optimum driving range-interior comfort combination.

### BACKGROUND OF THE INVENTION

Interior comfort control systems for motor vehicles are known. Such systems can include a heating, venting, air conditioning (HVAC) system that affords for increasing or decreasing a temperature of an interior of the vehicle. Such systems allow for a driver and/or a passenger in a motor vehicle to use a heater, vent, and/or air conditioner of the vehicle to heat or cool air entering the interior thereof. In this manner, an interior comfort of the vehicle per the driver and/or passenger of the vehicle can be adjusted as desired.

With the development of electric vehicles, extending the driving range of the vehicle between battery charges is desired. In addition, users of electric vehicles demand the ability to adjust the interior comfort of the vehicle. However, the use of a heater, vent, and/or air conditioner of the vehicle requires consumption of electric power that could be used for movement of the vehicle. Stated differently, use of the vehicle's interior comfort control system reduces the overall driving range for the vehicle. Therefore, an interior comfort control system that would allow a user of an electric vehicle to obtain an optimum driving range-interior comfort combination would be desirable.

### SUMMARY OF THE INVENTION

The instant disclosure provides an interior comfort control system that allows a driver and/or passenger of an electric vehicle to balance between driving range for the vehicle and interior comfort and thereby obtain an optimum driving range-interior comfort combination. In some instances, an electric vehicle having an interior and an interior comfort control module (ICCM) is provided. The ICCM can have an Off-Mode, a Normal-Mode, and an Eco-Mode. The Normal-Mode can be operable to reach a desired vehicle interior temperature using a first air temperature change rate and the Eco-Mode can be operable to reach the same desired vehicle interior temperature using a second air temperature change rate. In addition, the second air temperature change rate can be less than the first air temperature change rate. The ICCM can also have a controller that is operable to allow the driver and/or passenger of the electric vehicle to select the ICCM Off-Mode, Normal-Mode, and Eco-Mode. In this manner, the driver can select the Eco-Mode and obtain an extended driving range for the vehicle when compared to the driving range if the Normal-Mode is selected and yet also obtain a suitable interior comfort level for the interior of the vehicle.

The electric vehicle and/or ICCM can include at least one heater, vent, air conditioner and/or dehumidifier, and in some instances a seat heater. The Eco-Mode of the ICCM can activate the seat heater to increase interior comfort by providing heat to an individual sitting in the seat, reduce power used by the heater and still provide a desired interior comfort level. Stated differently, the ICCM in the Eco-Mode can use the seat heater to provide warmth to an individual within the vehicle and reduce power used by the heater.

In some instances, the Eco-Mode of the ICCM can include a Low Eco-Mode and a High Eco-Mode with the Low Eco-Mode operable to reach the desired vehicle interior temperature using the second air temperature change rate while the High Eco-Mode is operable to approach and/or reach the desired vehicle interior temperature using a third air temperature change rate. It is appreciated that the third air temperature change rate is less than the second air temperature change rate. It is also appreciated that the desired vehicle interior temperature (T_{desired}) can be different for one or more of the modes. For example and for illustrative purposes only, a Normal-Mode T_{desired} can be greater than a High Eco-Mode T_{desired} which can be greater than a Low Eco-Mode T_{desired}, or in the alternative, a Normal-Mode T_{desired} can be less than a High Eco-Mode T_{desired} which can be less than a Low Eco-Mode T_{desired}.

The electric vehicle and/or ICCM can also include a driving range meter that can display a driving range for the electric motor vehicle when the ICCM is in the Off-Mode, Normal-Mode, Eco-Mode, Low Eco-Mode, and/or High Eco-Mode. In addition, a visual display can be included that provides mode selection information to a user of the vehicle when the ICCM is in the Off-Mode, Normal-Mode, Eco-Mode, Low Eco-Mode, and/or High Eco-Mode.

The present invention also provides a process for allowing a user of an electric vehicle to balance between a driving range and an interior comfort level and thereby obtain an optimum driving range-interior comfort combination. The process includes providing an electric vehicle having the ICCM described above and allowing the driver to select the Eco-Mode of the ICCM. Selection of the Eco-Mode results in the ICCM reaching a desired vehicle interior temperature at a rate slower than when the ICCM is in the Normal-Mode. It is appreciated that selection of the Eco-Mode results in the ICCM using less power than when in the Normal-Mode and thus providing more power for movement of the vehicle while obtaining a suitable interior comfort level.

### BRIEF DESCRIPTION OF THE DRAWINGS

FIG. 1 is a schematic illustration of an electric motor vehicle with an interior comfort control module according to an embodiment of the present invention;

FIG. 2 is a graphical illustration of a first air temperature change rate and a second air temperature change rate for an electric vehicle using an interior comfort control module according to an embodiment of the present invention;

FIG. 3 is a graphical representation of a first air temperature change rate, a second air temperature change rate, and a third air temperature change rate for an electric vehicle with an interior comfort control module according to an embodiment of the present invention;

FIG. 4 is a graphical representation of a first air temperature change rate, a second air temperature change rate, and a third air temperature change rate for an electric vehicle with an interior comfort control module according to an embodiment of the present invention;

FIG. 5 is a schematic illustration of a visual display for an interior comfort control module according to an embodiment of the present invention;

FIG. 6 is a schematic illustration of a driving range meter for an embodiment of the present invention; and

FIG. 7 is a schematic illustration of a visual display for an interior comfort control module according to an embodiment of the present invention.

### DETAILED DESCRIPTION OF THE INVENTION

The disclosure provides an electric vehicle with an interior comfort control system that allows a user of the vehicle to balance between a driving range and an interior comfort level for an interior of the vehicle. As such, the present invention has utility as a component for an electric vehicle.

The electric vehicle and/or interior comfort control system can include an interior comfort control module (ICCM), the ICCM having an Off-Mode, a Normal-Mode, and an Eco-Mode. The ICCM in the Normal-Mode reaches a desired vehicle interior temperature using a first air temperature change rate and in the Eco-Mode reaches the desired vehicle interior temperature using a second air temperature change rate—the second air temperature change being less than the first air temperature change rate. A controller can also be included that allows for the driver or passenger of the electric vehicle to select the Off-Mode, the Normal-Mode, and/or the Eco-Mode. As such, a user of the motor vehicle can elect to heat or cool the interior of the vehicle at a reduced heating or cooling rate, respectively, in order to extend the driving range thereof. In addition, the ICCM can activate a seat heater in the vehicle in order to provide warmth to a user thereof while reducing power to a heater of the vehicle.

The ICCM can include at least one heater, vent, air conditioner, dehumidifier, and/or seat heater. In addition, the Eco-Mode can include a Low Eco-Mode and a High Eco-Mode with the Low Eco-Mode operable to reach a desired vehicle interior temperature using the second air temperature change rate and the High Eco-Mode operable to approach and/or reach the desired vehicle interior temperature using a third air temperature change rate, the third air temperature change rate being less than the second air temperature change rate.

The electric vehicle and the interior comfort control system can also include a driving range meter that can display a driving range for the electric vehicle when the ICCM is in the Off-Mode, Normal-Mode, Eco-Mode, Low Eco-Mode, and/or High Eco-Mode. Stated differently, the driving range meter can provide to a user of the vehicle a remaining driving distance as a function of the ICCM mode selected by a user of the vehicle. The electric vehicle and/or ICCM can further include a visual display that can provide a user of the vehicle visual information as to which mode, if any, the ICCM is currently in.

Turning now to FIG. 1, an electric vehicle containing an interior comfort control system according to an embodiment of the present invention is shown generally at reference numeral 10. The embodiment 10 can include an electric vehicle 100 that has a battery 110 and an occupant seat 230. In some instances, the vehicle 100 can contain a plurality of seats 230 and other components such as a steering wheel, brake pedal, acceleration pedal (not shown) and the like as is known to those skilled in the art. The embodiment can also include an interior comfort control system 200 that can have a heating, vent, and air conditioning (HVAC) module 210 and a controller 220. The HVAC module 210 can include a heater 212, vent 214, air conditioner 216, dehumidifier 218, and the like. Electronically attached to the HVAC module 210 is the controller 220 which can have a processor 222, the controller 220 and processor 222 operable to activate the HVAC module 210, regulate electric power from the battery 110 to the HVAC module 210, etc.

In some instances, the interior comfort control system 200 can include one or more seat heaters 232, the seat heaters 232 typically including electrical resistive wiring that provides heat to a bottom portion and/or back portion of the seat 230 as is known to those skilled in the art. In this manner, the controller 220 and/or processor 222, which can be in electronic communication with the scat heater 232 via pathway 240, can provide electrical power from the battery 110 to the seat 230 in order to provide heat to an individual sitting thereon. In some instances, use of the seat heater 232 can allow for reduced power used by the heater 212 and yet provide suitable comfort for an individual within the electric vehicle 100. Stated differently, warmth provided by the seat 230 with seat heater 232 can substitute for heated air provided by the heater 212 and required to obtain a desired level of interior comfort for an individual.

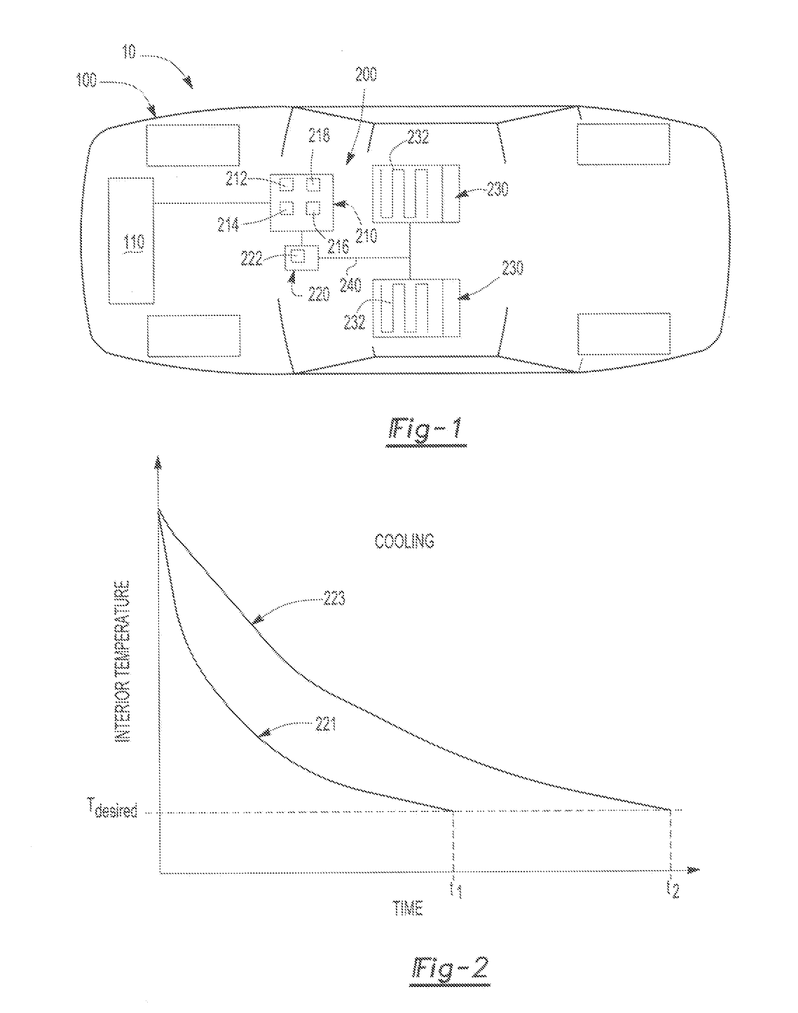

The interior comfort control system 200 can provide desired and/or suitable comfort to an individual within the electric vehicle 100 and yet consume less electrical energy from the battery 110 when compared to heretofore internal comfort control modules. In particular, the internal comfort control system 200 can afford for the air conditioner 216 to cool air blowing therethrough at a reduced cooling rate than when a user selects a normal operation of the air conditioner. For example, and with reference to FIG. 2, selection of a Normal-Mode using the controller 220 can provide a first air temperature change rate 221 that affords for the interior of the electric vehicle to reach a desired vehicle interior temperature (T_{desired}) at time t₁. However, the interior comfort control system 200 also allows a user of the vehicle 100 to select an Eco-Mode for the air conditioner 216 which provides a second air temperature change rate 223.

It is appreciated from FIG. 2 that the second air temperature change rate 223 is less than the first air temperature change rate 221 and, as such, affords for the internal comfort control system 200 and/or HVAC unit 210 to reach T_{desired} at a time t₂ which is greater than t₁. It is also appreciated that the electric power required for the first air temperature change rate 221 is greater than the electric power required for the second air temperature change rate 223. As such, less power is used or consumed by the air conditioner 216 to provide the second air temperature change rate 223 and more electrical power is available for movement of the vehicle 100. In addition, in some instances the second air temperature change rate can result in the desired interior temperature T_{desired} actually never being reached, i.e. T_{desired} is approached but not obtained during a particular driving trip.

Assuming that an individual within the interior of the vehicle 100 desires an increased driving range more than a reduced time to obtain a desired vehicle interior temperature, the interior comfort control system 200 affords for an increase in the driving range while still providing a desired interior comfort within a reasonable amount of time for a user of the vehicle 100. As such, the interior comfort control system 200 allows a user to obtain an optimum driving range-interior comfort combination.

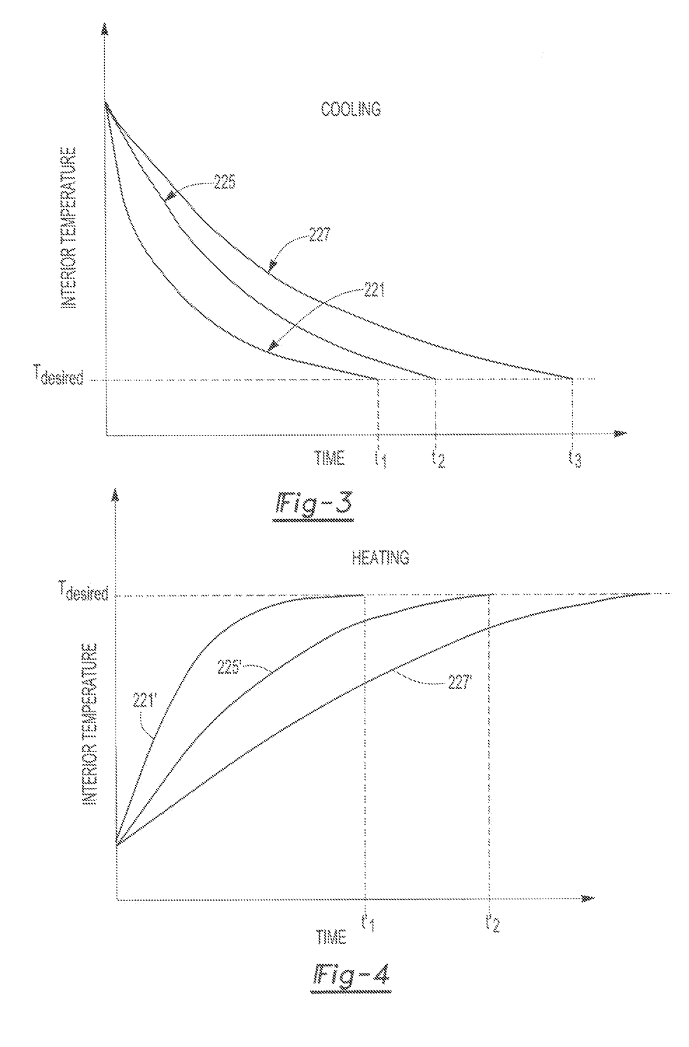

In some instances, the interior comfort control system 200 can include an Eco-Mode that has a Low Eco-Mode and a High Eco-Mode. The Low Eco-Mode can have a second air temperature change rate 225 as shown in FIG. 3 and the High Eco-Mode can have a third air temperature change rate 227. The second air temperature change rate 225 may or may not be equal to the second air temperature change rate 223 and it is appreciated that the third air temperature change rate 227 can be less than the second air temperature change rate 225. As such, less power can be supplied and used by the air conditioner 216 such that it cools air affords for the interior to approach and/or reach a desired temperature at a time t₃ which is greater than t₂.

In addition to the above, it is also possible that the third temperature change rate 227 can result in the desired vehicle interior temperature never being reached for a given set of environmental conditions, however, the interior comfort control system 200 provides a user the choice between an extended driving range with a reduced interior comfort and an increased interior comfort with a reduced driving range. Stated differently, the interior comfort control system 200 provides a user of the electric vehicle 100 the option to choose between extended driving range for the vehicle or an increased interior comfort, or vice versa. Furthermore, and with respect to cooling of the vehicle interior, a T_{desired} for the Normal-Mode can be less than a T_{desired} for the Low Eco-Mode which in turn can be less than a T_{desired} for the High Eco-Mode, i.e. T_{desired}(Normal-Mode)<T_{desired}(Low Eco-Mode)<T_{desired}(High Eco-Mode).

Turning now to FIG. 4, a graphical representation of different air temperature change rates is shown for heating of the interior for the vehicle 100. In particular, 221′ illustrates a first air temperature change rate provided by the heater 212 such that a desired vehicle interior temperature is reached at temperature t₁′. In addition, a second air temperature rate 225′ can be provided by the interior comfort control system 200 while the HVAC module 210 is in Eco-Mode, for example a Low Eco-Mode. The second air temperature change rate 225′ thus affords for reduced power consumption by the heater 212 in exchange for the desired vehicle interior temperature to be reached at a time t₂′ which is greater than t₁′. And similar to T_{desired} for cooling of the vehicle interior, the T_{desired} for heating of the vehicle interior does not have to be the same for each mode, i.e. the inventive system can provide for T_{desired}(Normal-Mode)>T_{desired}(Low Eco-Mode)>T_{desired}(High Eco-Mode) when the heater 212 is activated.

In addition to the above, the interior comfort control system 200 with the controller 220 and processor 222 can activate the heater 232 of the seat 230 before, during, and/or after the interior of the vehicle 100 has reached the desired vehicle interior temperature. In this manner, heat and/or warmth can be provided to an individual sitting on the seat 230 while the interior of the vehicle is being heated to the desired temperature. In the alternative, the heater 232 for the seat 230 can be used to reduce the desired vehicle interior temperature and yet provide a similar and/or adequate interior comfort level to an individual within the vehicle. As known to those skilled in the art, an amount of electrical energy to heat a seat heater can be substantially less than energy used to heat air with a heater. As such, a desired and/or adequate interior comfort level established through the use of a seat heater with less energy used by a heater can provide an overall reduction in energy use by the interior comfort control system 200.

Similar to FIG. 3, the interior comfort control system 200 can have a third air temperature change rate 227′ that affords for the desired vehicle interior temperature to be approached at a slower rate than the second air temperature change rate 225′ and the first air temperature change rate 221′. It is appreciated that the second air temperature change rate 225′ and/or third air temperature change rate 227′ can be such that T_{desired} is not actually reached or obtained during a particular driving trip. In this manner, additional energy can be available for the movement of the vehicle 100 and yet desired and/or adequate interior comfort level be provided for one or more individuals using the vehicle 100. It is appreciated that the interior comfort control system 200 can use the seat heater 232 with the third air temperature change rate 227′ as discussed above for the second air temperature change rate 225′. Furthermore, the first air temperature change rate 221′ can be associated with a Normal-Mode of operation for the HVAC module 210, the second temperature change rate 225′ can be associated with an Eco-Mode or Low Eco-Mode, and the third air temperature change rate 227′ can be associated with a High Eco-Mode.

In addition to the heater 212, vent 214, and air conditioner 216, the HVAC module 210 can include a dehumidifier 218. The dehumidifier 218 can be used to reduce energy required to heat or cool air entering the interior of the vehicle 100 by reducing the humidity of air entering the HVAC module 210.

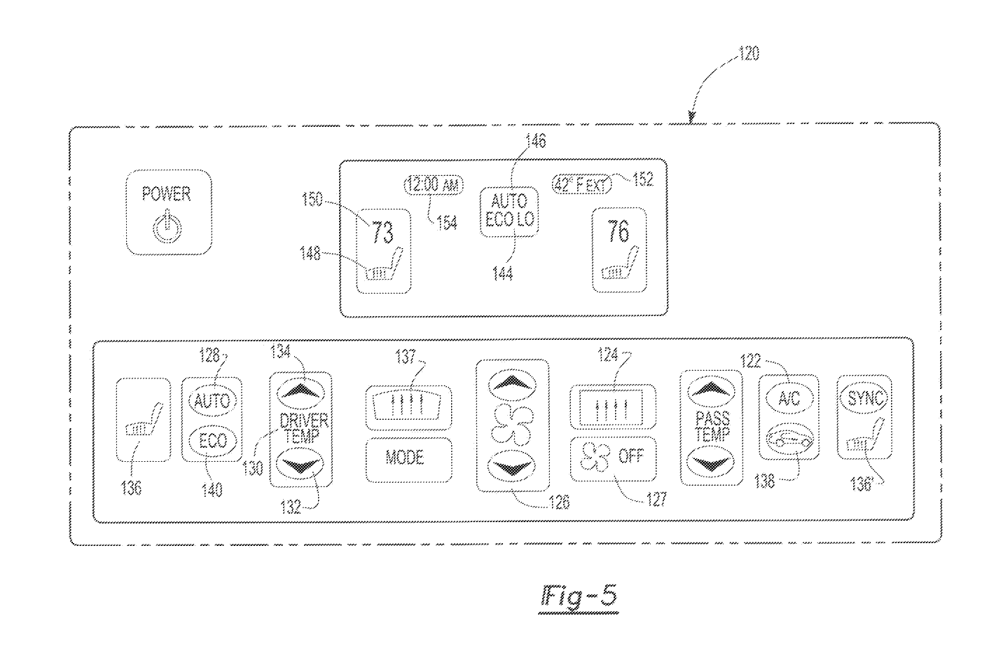

Turning now to FIG. 5, a schematic representation of a visual display 120 for the embodiment 10 is shown. The display 120 can include a plurality of switches, visual display areas, and the like. For example, the display 120 can include an air conditioning (A/C) switch 122, a rear defroster switch 124, a fan motor increase and decrease switch 126, and a fan off switch 127. It is appreciated that the fan increase and decrease switch 126 can be used to increase and decrease the flow rate of air entering into the interior of the vehicle 100. In addition, the A/C switch 122 can be used to activate the air conditioner 216 illustrated in FIG. 1.

In the alternative, an AUTO switch 128 can be activated such that the heater 212, vent 214, and air conditioner 216 are automatically activated to reach a desired vehicle interior temperature. Stated differently, when the AUTO switch 128 is activated, the processor 222 can automatically activate the HVAC module 210 in order for a desired vehicle interior temperature to be obtained.

In some instances, the driver of the vehicle 100 can have an independent selection of desired interior temperature using a driver temp switch 130 that has a temperature decrease temperature switch 132 and a temperature increase switch 134. As known to those skilled in the art, the driver can set the desired interior temperature for the driver's side or area of the interior using such a switch 130. Although not labeled, a passenger can have a similar switch (PASS TEMP) as shown in the figure.

A driver seat heater activation switch 136 can be included in the display, the switch 136 affording for the controller 220 and/or the processor 222 activating the seat heater 232 of at least one of the seats 230. In some instances, a seat heater activation switch 136′ can be provided for a passenger of the vehicle 100. In addition, a front windshield defroster switch 137 and/or an air recirculation switch 138 can be included, the switch 138 resulting in air already within the interior of the vehicle 100 being recirculated through the HVAC module 210 for heating or cooling rather than heating or cooling fresh air from the exterior of the vehicle.

An Eco-Mode switch 140 can be present on the display 120, the Eco-Mode switch 140 providing for an alternative temperature change rate and/or activation of a seat heater as discussed above. In addition, the Eco-Mode switch 140 can be activated to provide a Low Eco-Mode and/or a High Eco-Mode. For example and for illustrative purposes only, the Eco-Mode switch 140 can be depressed one time for activation of a Low Eco-Mode or depressed two times for activation of a High Eco-Mode.

As shown in FIG. 5, a display region 144 can provide a visual display to an individual in the vehicle 100 which Eco-Mode, if any, is presently activated. Likewise, other modes presently activated and/or in use can be provided at regions such as 146, along with other information such as an outside temperature display region 152, a current time display region 154, and the like. Furthermore, the present temperature within the interior of the motor vehicle can be provided at a region 150 as can an indication that the seat heater is activated as shown at 148. It is appreciated that the display shown in FIG. 5 is for illustrative purposes only and the location and/or presence of the various switches and display areas can be altered, modified, and the like and yet still be within the scope of the present invention.

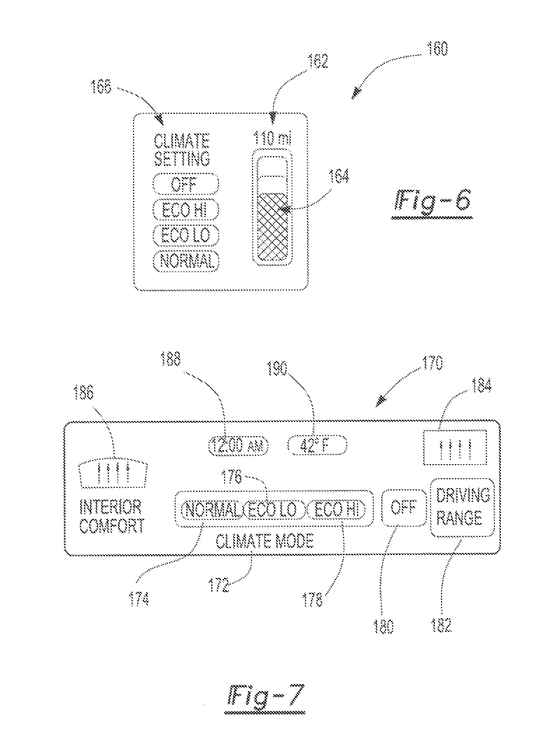

In addition to a visual display as shown in FIG. 5, a driving range meter can be included as illustratively shown at reference numeral 160 in FIG. 6. The driving range meter 160 can include a driving range 162 along with a present climate setting 166. In addition, the driving range 162 can change based on the climate setting 166, as can a meter reading 164. Stated differently, a user and/or occupant of the vehicle 100 can determine a driving range for the vehicle 100 given the current climate setting 166 that has been selected.

As indicated above and shown in FIGS. 2-4, it is appreciated that selection of a Normal-Mode climate setting would result in a reduced driving range 162 whereas selection of an OFF climate setting 166 would provide an increased and maximum driving range 162. In addition, selection of an intermediate climate setting 166, for example a Low Eco-Mode or High Eco-Mode, would result in an increased driving range 162 when compared to the Normal-Mode climate setting 166. Again, in this manner a user of the vehicle 100 can select an optimum driving range-interior comfort combination that meets his or her individual preference.

The interior comfort control system can also include a visual display as shown in FIG. 7 at reference numeral 170, the display 170 providing a climate mode display region 172 with a region 174 that illustrates whether the interior comfort control system 200 is currently in an Off-Mode, a Normal-Mode, an Eco-Mode, Low Eco-Mode, High Eco-Mode and the like. In addition, a driving range portion 182 can be included, along with additional information such as a rear defroster signal 184, a front defroster signal 186, a current time display 188, an exterior temperature display 190, and the like. As such, the electric vehicle 100 with the interior comfort control system 200 can include any number of displays, driving range meters, and the like that provide information to a user of the vehicle regarding comfort, driving range, etc.

A process for allowing a driver of an electric vehicle to balance between driving range and interior comfort is also provided. The process allows the driver, in addition to a passenger in the vehicle, to obtain an optimum driving range-interior comfort combination. The process includes providing an electric vehicle such as the vehicle 100 in FIG. 1, the vehicle 100 having the interior comfort control system or module 200. The interior comfort control system 200 can have the heater 212, vent 214, air conditioner 216, and/or dehumidifier 218. The system 200 also can include an Off-Mode, a Normal-Mode of operation, and an Eco-Mode of operation as described above.

The controller 220 is provided and the driver and/or passenger is allowed to select between the plurality of operation modes, the particular selection resulting in an air temperature change rate to be used to approach and/or reach a desired vehicle interior temperature. Depending on which particular mode is selected, the driving range for the vehicle 100 can be reduced or increased and thus allow a user of the vehicle to select between increased driving range, obtaining a desired vehicle interior temperature at a faster or slower rate, and possible use of a seat heater to obtain warmth while reducing power consumption by the heater 212. In this manner, an optimum driving range-interior comfort combination best suited for an individual within the vehicle is provided.

Based on the above examples, embodiments, and the like, it should be appreciated that various changes, modifications, additions, and subtractions can be made to the above disclosed system and process and yet remain within the scope of the invention. In addition, it is appreciated that the switches described above can be in electronic connection with the HVAC unit and the like and be used to activate/energize an associated component as is known to those skilled in the art. The foregoing is illustrative of specific embodiments of the invention but is not meant to be a limitation upon the practice thereof. It is the following claims, including all equivalents, which define the scope of the invention.

We claim:

1. An interior comfort control system that allows a driver of an electric vehicle to balance between driving range and interior comfort and thereby obtain an optimum driving range-interior comfort combination, said system comprising:
an electric vehicle having an interior and an interior comfort control module (ICCM);
said ICCM having an Off-Mode, a Normal-Mode and an Eco-Mode, said ICCM in said Normal-Mode operable to reach a desired vehicle interior temperature using a first air temperature change rate and said ICCM in said Eco-Mode operable to reach said desired vehicle interior temperature using a second air temperature change rate; and
a controller operable for the driver of said electric vehicle to select said Off-Mode, said Normal-Mode and said Eco-Mode;
said second air temperature change rate being less than said first air temperature change rate, for the purpose of extending a driving range for said electric vehicle.

2. The system of claim 1, wherein said ICCM has at least one of a heater, vent, air conditioner, dehumidifier and seat heater.

3. The system of claim 2, wherein said ICCM in said Eco-Mode activates said seat heater to increase interior comfort and reduce power used by said heater to provide interior comfort to the driver and reduce power consumption by said ICCM.

4. The system of claim 2, wherein said Eco-Mode has a Low Eco-Mode and a High Eco-Mode, said ICCM in said Low Eco-Mode operable to reach said desired vehicle interior temperature using said second air temperature change rate and said ICCM in said High Eco-Mode operable to approach said desired vehicle interior temperature using a third air temperature change rate, said third air temperature change rate being less than said second air temperature change rate.

5. The system of claim 4, further comprising a driving range meter operable to display a driving range for said electric motor vehicle when said ICCM is in said Normal-Mode, said Low Eco-Mode and said High Eco-Mode.

6. The system of claim 5, further comprising a visual display operable to display when said ICCM is in said Off-Mode, Normal-Mode, Low Eco-Mode and High Eco-Mode.

7. An interior comfort control system that allows a driver of an electric vehicle to balance between driving range and interior comfort and thereby obtain an optimum driving range-interior comfort combination, said system comprising:
an electric vehicle having an interior and an interior comfort control module (ICCM) having a heater, vent, air conditioner, dehumidifier and seat heater;
said ICCM also having an Off-Mode, a Normal-Mode and an Eco-Mode, said ICCM in said Normal-Mode operable to reach a desired vehicle interior temperature using a first air temperature change rate and said ICCM in said Eco-Mode operable to reach said desired vehicle interior temperature using a second air temperature change rate, said second air temperature change rate being less than said first air temperature change rate; and
a controller operable for the driver of said electric vehicle to select said Off-Mode, said Normal-Mode and said Eco-Mode.

8. The system of claim 7, wherein said ICCM in said Eco-Mode activates said seat heater and reduces power supplied to said heater compared to said ICCM in said Normal-Mode, for the purpose of increasing interior comfort and reducing power used by said heater when providing interior comfort to the driver.

9. The system of claim 7, wherein said Eco-Mode has a Low Eco-Mode and a High Eco-Mode, said ICCM in said Low Eco-Mode operable to reach said desired vehicle interior temperature using said air second temperature change rate and said ICCM in said High Eco-Mode operable to reach said desired vehicle interior temperature using a third air temperature change rate, said third air temperature change rate being less than said second air temperature change rate.

10. The system of claim 9, further comprising a driving range meter operable to display a driving range for said electric motor vehicle when said ICCM is in said Normal-Mode, said Low Eco-Mode and said High Eco-Mode.

11. The system of claim 10, further comprising a visual display operable to display when said ICCM is in said Off-Mode, Normal-Mode, Low Eco-Mode and High Eco-Mode.

12. A process for allowing a driver of an electric vehicle to balance between driving range and interior comfort and thereby obtain an optimum driving range-interior comfort combination, the process comprising:
providing an electric vehicle having an interior and an interior comfort control module (ICCM) having a heater, vent, air conditioner,
the ICCM also having an Off-Mode, a Normal-Mode and an Eco-Mode;
the ICCM in said Normal-Mode operable to reach a desired vehicle interior temperature using a first air temperature change rate and the ICCM in the Eco-Mode operable to reach the desired vehicle interior temperature using a second air temperature change rate, the second air temperature change rate being less than the first air temperature change rate;
providing a controller operable for the driver of the electric vehicle to select the Off-Mode, the Normal-Mode and the Eco-Mode of the ICCM;
allowing the driver of the vehicle to select the Eco-Mode of the ICCM, selection of the Eco-Mode resulting in the ICCM reaching the desired vehicle interior temperature at a rate slower than when the ICCM mode is in Normal-Mode, selection of the Eco-mode also resulting in the ICCM using less power than when in the Normal-Mode and providing more power for movement of the vehicle and allowing the driver to obtain an optimum driving range-interior comfort combination.

13. The process of claim 12, further including a seat heater as part of the ICCM.

14. The process of claim 13, wherein the ICCM in the Eco-Mode provides power to the seat heater while reducing power to the heater when the desired vehicle interior temperature requires use of the heater and thereby resulting in the ICCM providing interior comfort while using less power than when just the heater is being powered.

15. The process of claim 12, further including providing a driving range meter to display a driving range for the electric motor vehicle when the ICCM is in the Normal-Mode and the Eco-Mode.

16. The process of claim 12, further including providing a visual display to display when the ICCM is in the Normal-Mode and the Eco-Mode.

17. The process of claim of claim 12, further including the ICCM having a Low Eco-Mode and a High Eco-Mode, the ICCM in the Low Eco-Mode using the second air temperature change rate to reach the desired vehicle interior temperature and the ICCM in the High Eco-Mode using a third air temperature change rate to approach the desired vehicle interior temperature, the third air temperature change rate being less than the second air temperature change rate.

18. The process of claim 17, further including providing a driving range meter to display a driving range for the electric motor vehicle when the ICCM is in the Normal-Mode, the Low Eco-Mode and the High Eco-Mode.

19. The process of claim 17, further including providing a visual display to display when the ICCM is in the Normal-Mode, the Low Eco-Mode and the High Eco-Mode.
